(19) United States
(12) Patent Application Publication
(10) Pub. No.: US 2007/0030139 A1
(43) Pub. Date: Feb. 8, 2007

(54) Method and apparatus for reducing road rage

(76) Inventors: Marilyn McLeod Ellison, Winnetka, CA (US); Marvin Ellison, Riverside, CA (US)

Correspondence Address: John E. Wagner, Esq.;LAW OFFICE OF JOHN E. WAGNER, 3541 OCEAN VIEW BLVD., Glendale, CA, 91208, US

(21) Appl. No.: 11/498,452

(22) Filed: Aug. 2, 2006

Related U.S. Application Data
(60) Provisional application No. 60/705,235, filed on Aug. 2, 2005.

(51) Int. Cl. G08B 5/22

(52) U.S. Cl. 340/482

(57) ABSTRACT

Apparatus and methods are disclosed for reducing road rage by providing signage, lighted or not which is displayable through a window, usually the rear window of a vehicle having messages or two or three types only. A message of appreciation such as THANK YOU or of a conciliatory type are available. The messages are preferably illuminated and controlled by a switch available to the driver while normally driving without any distraction.

### REFERENCE TO RELATED APPLICATION

This non-provisional patent application claims benefit of U.S. provisional patent application Ser. No. 60/705,235 filed Aug. 2, 2005, and hereby claims the benefit of the embodiments therein and of the filing date thereof.

### BACKGROUND OF THE INVENTION

In recent years, with the increase in traffic density throughout the nation and the world, a new phenomenon has developed. It has reached the level of every day news reports of incidents occurring between drivers on express or freeways or even city streets. In such a typical situation, one vehicle, either intentionally, or most likely unintentionally, interferes with a second vehicle. Often, the interfering vehicle driver is unaware of what he has done, such as cutting in front of a vehicle in an adjacent lane or failing to give way to another lawfully operated vehicle.

Although no statistics are available, it is believed that the vast majority of such minor indiscretions or offenses occurred unintentionally. When an unintended interference of another vehicle occurs, the offending driver often feels remorse, but there is very little that can be done to calm the feeling of the other vehicle driver.

These minor indiscretions have in all too numerous cases resulted in physical violence between the offending and the offended drivers. Some drivers are known to carry lethal weapons, whether legal or not, and have shot and injured or killed the offending party, often racing away from the scene and destroying, not only the well-being of the offending driver but their family as well and sometimes injury or damage to other drivers and their vehicles. This set of incidents has occurred to often enough that it has been given a name “ROAD RAGE”.

Where the action by the offending party was intentional, there is very little that can be done, but this invention, if used, can only calm the situation.

Lately, the applicants have recognized that there needs to be some way to communicate a message to other drivers to enlist their assistance in traffic situations and to express appreciation for assistance given. On the other hand, when the driver equipped with signaling capability recognizes that he has interfered with another driver, he has the ability to express an apology. Upon giving such a signal, it is believed that an offended party will accept an apology and the matter never proceeds aggressively beyond that stage.

In another set of circumstances, a driver recognizes that a lane change or some other movement is required by his vehicle that needs some cooperation on the part of another driver or drivers. Side view mirrors and turn indicators, as well as emergency flashing lights, at present, are the only signals which can be given before taking the necessary movement.

Most drivers are perfectly willing to give away and assist another driver in need of a lane change once the need is recognized. When a driver receives assistance from other drivers, there is very little they can do to express appreciation, except a possible hand wave, indicating “thank you” for your cooperation. If a driver needs to make requests for assistance, for example, to make a right lane change, there is little that can be done other than use the turn indicators.

As experienced drivers encountering these situations, it has occurred to us that the phenomenon of ROAD RAGE could be largely eliminated if it were possible for a driver

(a) in need of cooperation from other drivers, or (b) wishing to express appreciation; (c) wishing to apologize for a roadway indiscretion could automatically give a suitable signal without distracting other drivers from the needs of driving in crowded roadways. An illuminated or other positive message sign are possibilities.

### BRIEF DESCRIPTION OF THE INVENTION THE APPARATUS

We have accomplished the desired results of producing a device and method for reducing ROAD RAGE through the presence of a preferably rear facing illuminated sign controlled by a manual switch convenient to the driver, which preferably has only three or four selections or positions, namely,
OFF
a message of appreciation
a request, or
a conciliatory message.

The selector switch used to illuminate the sign is connected to the vehicle battery through the ignition switch so that it can only be turned on when the ignition switch is in the ON position. The switch position selected will illuminate a request, an appreciation signal or a conciliatory message such as “I'M SORRY”. The driver is unable to signal a negative message.

In the preferred embodiment, the system includes a housing with a transparent window capable of generating messages of type I and one of type 2. Within the housing are a pair of lamps positioned to illuminate a message line 1, and the second to illuminate a message 2. When the selection is in the central position, the sign is not illuminated. Virtually no distraction is involved; UP is positive and DOWN is negative. Central is OFF.

A second embodiment is somewhat more complicated and versatile. A similar housing, as in the case of the preferred embodiment, includes in a rear facing window a plurality, for example 200, openings, each with individual illuminating devices, for example LEDs (light-emitting diodes) positioned by each opening. A control is present which will illuminate selective LEDs to produce a message in a pattern of lighted LEDs. A controller contains more than one message of each type which may be selected by the user but does not allow the selection of any but the stored positive messages. This embodiment, although somewhat more complex, allows larger messages in the same size housing and a variety of messages.

In all cases as indicated above, only positive messages are allowed in the system and can have a fundamental object of reducing ROAD RAGE.

Alternate forms of this invention are a self-contained, lighted or unlighted signs, either of which has a message panel and a convenient handle that may be held by any one in the vehicle to send a positive message. If lighted, the sign is battery powered, for example, by batteries in an enclosure, e.g., contained in the handle. The sign is double sided with an appreciation message on one face and an apologetic message on the opposite face. Both sides may be illuminated by one switch or separate switches to illuminate only the selected message.

Unlit message boards may also be utilized with large, easily read messages on each face. Different background colors will help the user to identify which sign is displayed without having to carefully read the message.

### BRIEF DESCRIPTION OF THE DRAWING

This invention may be more clearly understood from the following detailed description and by reference to the drawing, in which:

FIG. 1 is a rear elevational view of a vehicle, such as an automobile, with the illuminated sign of this invention shown in a window of the vehicle carrying a conciliatory message;

FIG. 1A is a view of the steering wheel of the vehicle of FIG. 1 with the operating switch on the steering wheel convenient for operation;

FIG. 2 an enlarged rear view the sign of FIG. 1 with a message of appreciation illuminated;

FIG. 3 is a simplified block diagram of the embodiment of FIGS. 1 and 2;

FIG. 4 is a vertical side sectional view of the housing for the sign of FIGS. 1 and 2 showing the two lamps used to illuminate the upper conciliatory message or the lower appreciation message;

FIGS. 5 and 5A show, for purpose of illustration only, the two messages both illuminated in different areas of the rear-facing window of FIGS. 1 and 2;

FIG. 6 is a partial vertical sectional view of the housing of FIGS. 1 to 3 employing a plurality of illuminating LEDs and a controller within the housing to generate a variety of positive messages which produce a number of messages by illuminated dots of light;

FIG. 7 is an rear face of the housing of FIG. 6 showing a matrix of diodes which can make a large variety of messages of positive nature under the control of the controller shown in FIG. 6;

FIG. 8 is a side elevational view, partly in section, of a portable-type sign in accordance with this invention in which the display may be temporarily or permanently attached to a window of a vehicle;

FIG. 9 is a chart of positive messages of a request for traffic assistance, appreciation request, or a conciliatory message of illuminated LEDs;

FIG. 10 is a front elevational view of a portable hand-held, self-contained battery powered version of this invention partially broken away to see the internal features of this embodiment;

FIG. 11 is a rear side elevational view of the portable hand held version of FIG. 10;

FIG. 12 is a schematic diagram of the circuit of the embodiment of FIGS. 10 and 11;

FIG. 13 is an exemplary front elevational view of the non-illuminated version of the invention;

FIG. 14 is an exemplary rear elevational view of the version of FIG. 12; and

FIG. 15 is a side elevational view of the embodiment of FIGS. 12 and 13.

### DETAILED DESCRIPTION OF THIS INVENTION

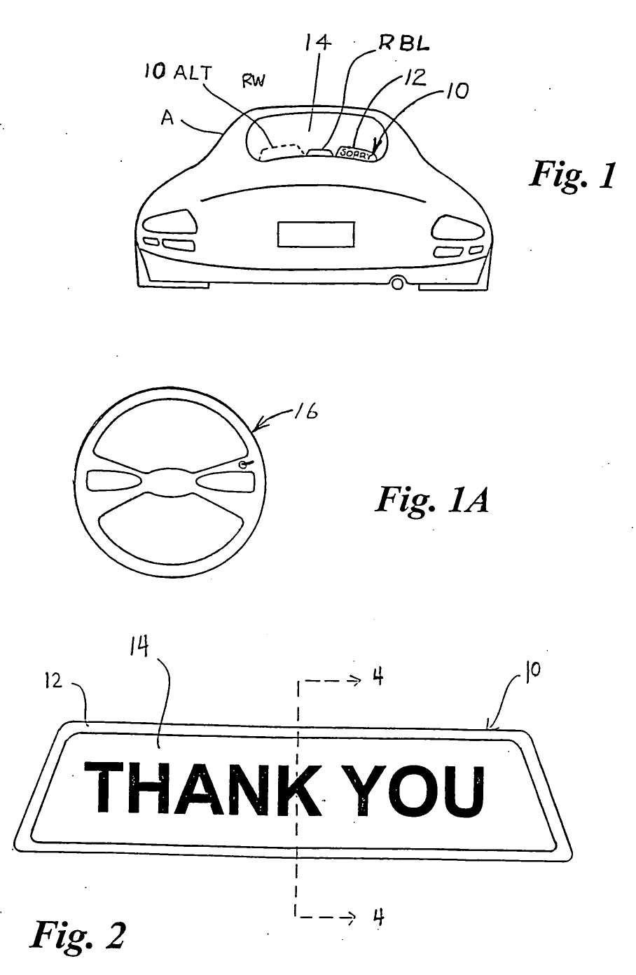

Now referring to FIGS. 1 through 3 of the drawings, wherein the basic combination of this invention may be seen in FIG. 1, a vehicle, such as automobile A, with its rear window RW, is shown as is normally seen by the following vehicle in a traffic situation. Positioned in view of the following vehicle is a sign assembly 10 which is normally unilluminated but under the control of the driver of the vehicle A to display one or more positive messages affecting the relationship of vehicle A and its following vehicle. This is the situation that we believe is the one that creates many of the problems which gives rise to ROAD RAGE. An unexpected or undesired movement by vehicle A can cause the driver of the following vehicle to be disturbed, warranted or not, but a situation which can give rise to possible accidents or confrontations between drivers.

Quite often, the driver of Vehicle A is unaware, at least initially, that his action may have interfered with the following vehicle, when he discovers that fact he may find it difficult or impossible to express his apology except by hand signals, which, at best, are ambiguous and at worst appear to be adversarial.

As seen in FIG. 1, the message displayed “I'M SORRY” is apologetic; and, it is believed, as with most apologies, will be accepted and the matter closed. FIG. 1 also shows in dashed line an alternate left-hand position for the display assembly 10 of this invention. Between the two positions centered in the rear window is the rear window brake light RWBL, which is found in recent models of automobiles. Neither the left nor the right position 10 or 10 ALT interferes with the location or operation of the rear window brake light RWBL.

This invention may be used to allow vehicle A to transfer to the same lane or to transfer through that lane to effect an exit. Of course, the use of such signals find their most common use on freeways or multilane throughways but can be equally effective in an urban or rural traffic situation. The two signals of FIGS. 1 and 2 can be displayed in the situation where the driver of vehicle A has somehow committed a traffic indiscretion, displaying I'M SORRY followed by THANK YOU.

Fundamental to this invention is the fact that only apologetic, conciliatory or appreciative messages may be displayed. As illustrated in FIGS. 1-3, the assembly 10 includes a housing 12, if an aftermarket device, or may be integrated into the vehicle as in the case of rear window facing brake lights but separate from and of different coloring, e.g. white and not red. The housing 12 of FIGS. 1 and 2 positions a screen or window 14 of FIG. 2 which shows an appreciative message normally that has no visible message when not illuminated and therefore is not a distraction.

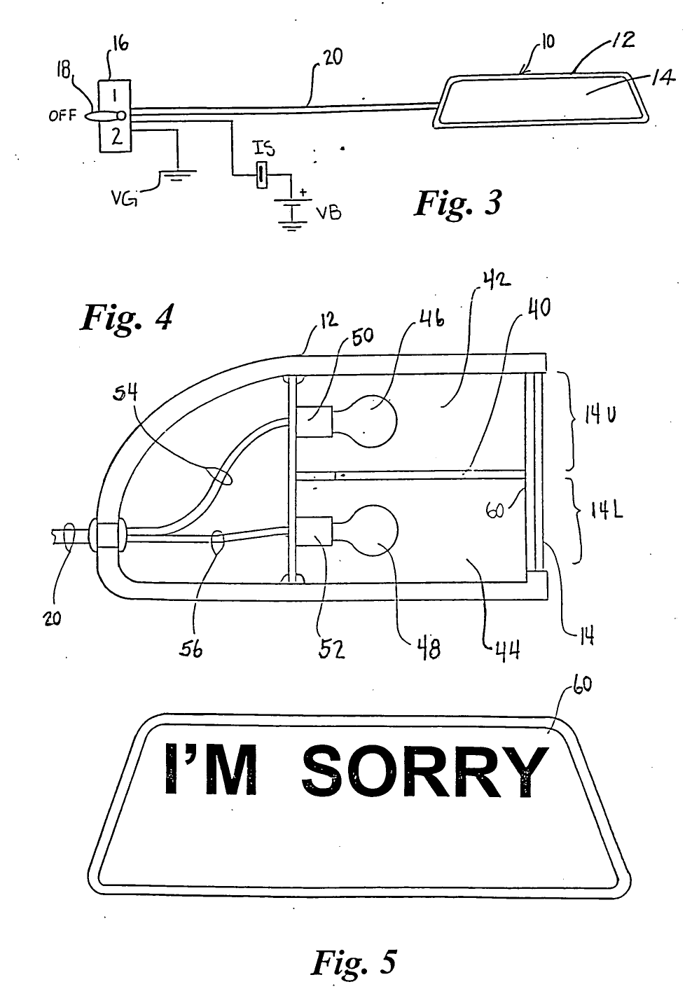

The basic operative system diagram is illustrated in FIG. 3. It comprises a multi-position switch 16 having an OFF position, typically centrally located, an upper position labeled for simplicity as 1 and a lower position labeled 2, and a switch-operating lever 18. Typically, the upper position 1 is used to display an appreciative message, such as “THANK YOU”, and the lower position 2 displays a conciliatory message such as “SORRY”.

In the simplest embodiment of this invention, the switch 16 is connected on one side to the vehicle ground indicated by the symbol VG and through the vehicle key operation ignition switch IS, to the vehicle battery VB. Cable 20 connects the switch to the assembly 10 which provides the illuminated messages.

The concept of this invention is to provide a limited number of positive messages to the user, which may be displayed with a simple switch action that lacks any confusion. The multi-position switch 18, preferably includes a self-canceling timer as is well known in the switch art to allow the driver to send the message and forget it while attending to driving.

Now referring to FIG. 4, which is a vertical sectional view taken along line 4-4 of FIG. 2. The housing 12 is shown as having two compartments separated by a horizontal wall 40 which defines two light chambers, a upper chamber 42 and a lower chamber 44, each containing a socket and separate lamps 46 and 48 in their respective sockets 50 and 52. Separate sets of lead wires 54 and 56 provide power from the vehicle battery VB through switches IS and 16 to illuminate either the upper portion 14U or lower portion 14L of window 14.

The window 14 is preferably of glass or transparent plastic sheet to close the housing 12. Behind the window 14 is a template 60, best seen in FIG. 4, carrying two messages in the form of cutout letters that allow the light from the respective lamps 46 and 48 to illuminate either the upper region or lower region of the window 14 to display either “THANK YOU”, when the switch operator 18 of FIG. 3 is moved upward, or “I'M SORRY”, when the switch operator 18 is moved downward, as in FIG. 3. These two messages are shown in FIGS. 5 and 5A.

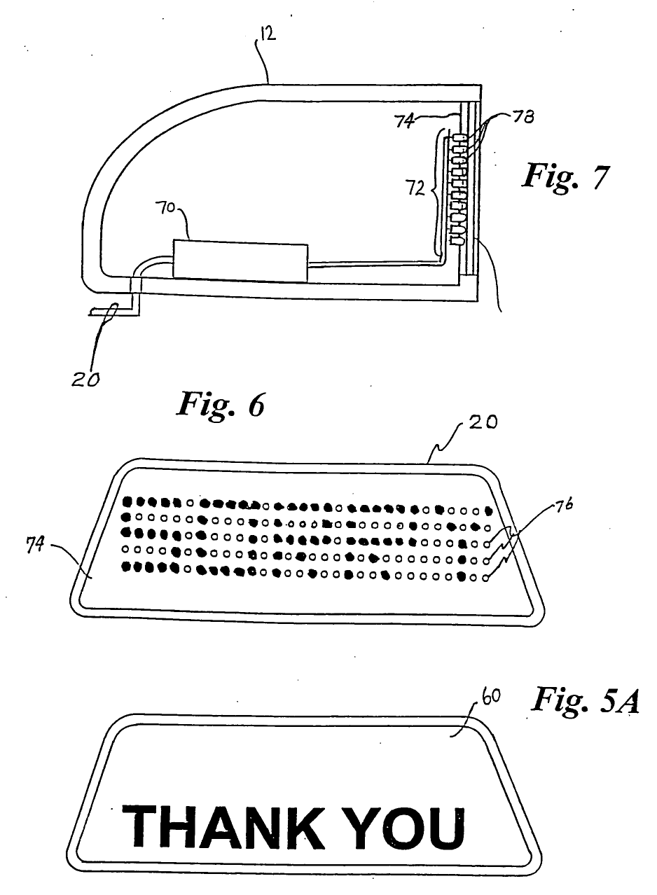

A more complex embodiment of this invention is illustrated in FIGS. 6 through 8 in which a larger number of messages may be preselected to be illuminated in advance but not while driving where it could be a distraction. This embodiment is illustrated in FIG. 6 where the illuminated lamps 78 are represented by the solid black dots which spell out the word “I'M SORRY” while the remaining lamps 78 remain unlit and are represented by empty circles.

FIG. 7 shows a vertical sectional view similar to FIG. 4 except that it includes a controller 70 and an array of lamps 72 positioned behind a mask 74 which has an opening for each lamp 78 as shown in FIG. 7. The lamps 78 of array 72 may be incandescent lamps or may be the conventional low cost LEDs (light emitting diode) relatively new high powered LED types which can fit in the individual openings 76 of the mask 74 and produce a message depending upon which particular lamps 78 are illuminated at one time.

The controller 70 may include memory for storage of messages and is programmed to display any of a number of appreciative and/or conciliatory messages. The same multi-position switch 18 as used in FIG. 3 can provide two messages selected from the stored positive messages in the memory of the controller 70. This arrangement also allows for the message to be the same message as above but in a different language of choice by the user, for example, in French, “PARDON MOI (pardon me)” or “MERCI BEAUCOUP (thank you)” for “I'M SORRY” OR “THANK YOU” in English. Again, fundamental to the success of this invention in preventing ROAD RAGE is the fact that only positive messages are stored and illuminated by the apparatus of FIGS. 1-7.

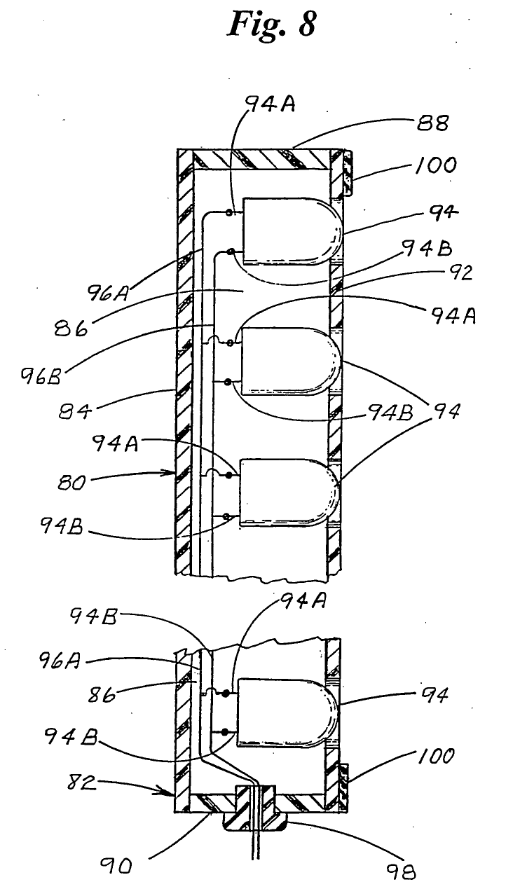

Now referring to FIG. 8, where a flat panel version of this invention is shown. This flat panel assembly, generally designated 80, comprises a generally rectangular insulated housing 82 with sealed rear wall 84, side walls 86, one of which may be seen in FIG. 8, top and bottom walls 88 and 90. The housing 82 is closed on its front by front wall 92, which supports and exposes an array of LEDs 94 to provide messages such as is illustrated in FIG. 7. Each LED 94 may be imbedded in openings as shown in FIG. 7A or otherwise supported. One common lead 96A is connected to one terminal 94A of each LED 94 and the second common line 94B is connected to individual terminals generally designated 96B. All the leads 96A and 96B are insulated and exit the housing 84 through an opening in bottom wall 90 and through a rubber or plastic grommet 98.

The flat panel assembly carries on its front face 92, adhesive covered tape 100 to allow temporary or personal attachment to windows of the vehicle.

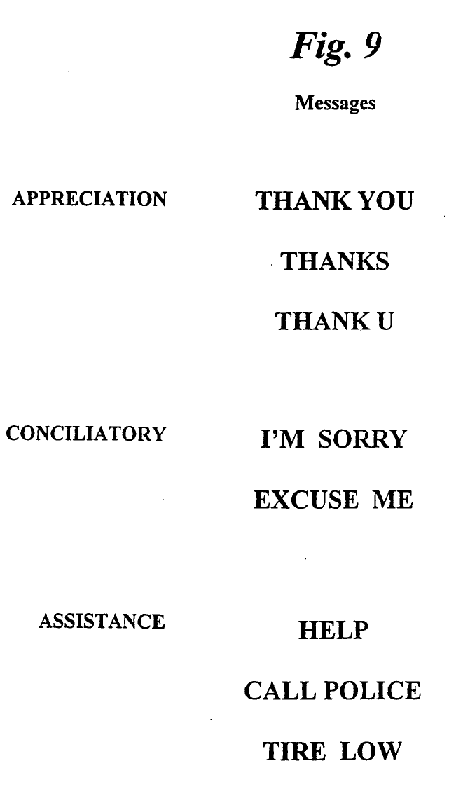

FIG. 9 illustrates a number of positive messages which may be incorporated into this invention. The primary messages constituting the preferred embodiment are:
THANK YOU
   and
I'M SORRY

The concept is to provide only two messages which are selectable without the need for the driver to take their attention away from driving. Only manual operation of a convenient switch is needed. In the manual version described below, the handgrip may be asymmetrical, e.g., tapered in thickness, or the background different to allow easy, rapid message selection.

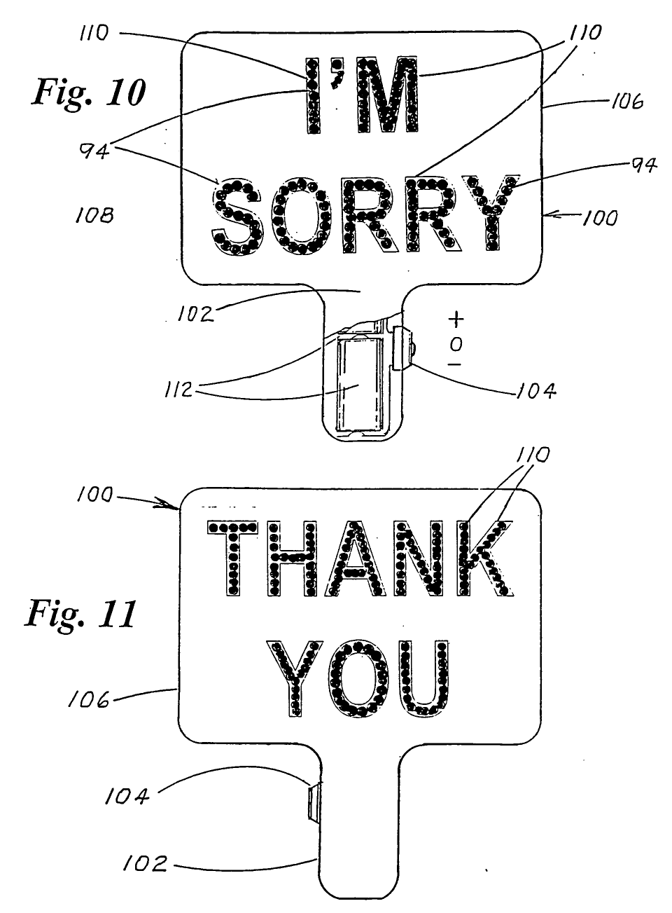

Now referring to FIGS. 10 through 12 for a hand held, self-powered sign system, in accordance with this invention. A paddle-type sign, generally designated 100, includes a handle portion 102 with a switch 104 and a blade or paddle portion 106. The handle portion 102 encloses batteries, unshown in the figure, but illustrated below. The blade or paddle portion 102 is hollow and mounts a plurality of lamps, LEDs 94 in a pattern making an appreciative message THANK YOU in lights. The array of lights 94 is on a neutral background 108, such as white, and the LEDs may be outlined in a contrasting color such as green, blue or black, for daylight visibility.

FIG. 11 shows the reverse side of FIG. 10 with a conciliatory message in LEDs 94 shown on a plain background 108, which may be white or other color with the conciliatory message in a contrasting color 110, such as green, blue or black. This allows the message to be easily read in daylight as well as at night. The LEDs 94 may be white, green, and red, as is desired for contrast and visibility. Batteries 112 are connected through switch 104 to the LEDs.

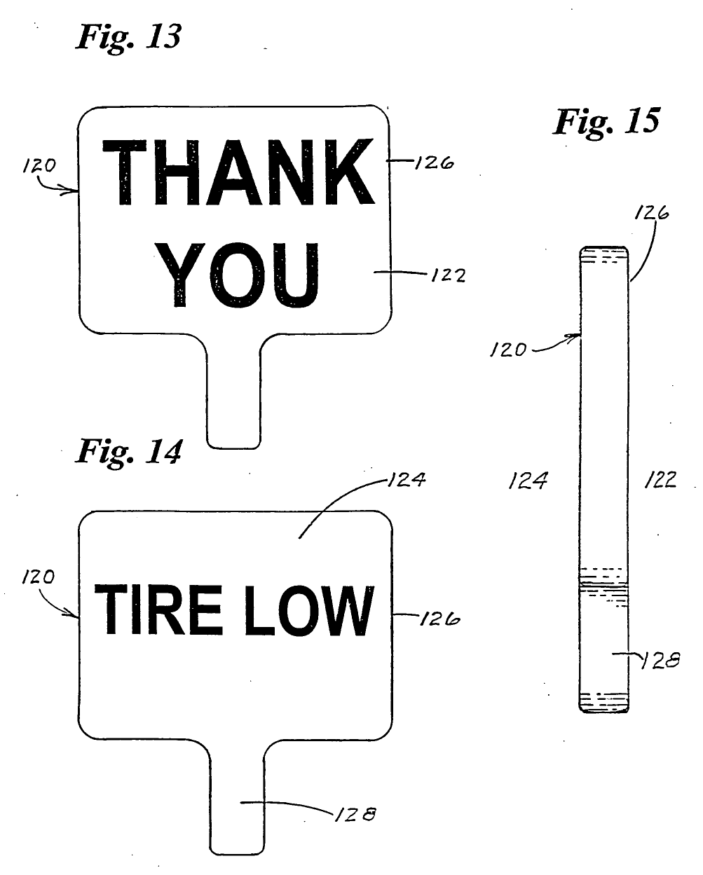

FIGS. 13, 14, and 15 show the opposite sides of a non-electric paddle or blade sign in accordance with this invention. In this case, the paddle 120 can be the same or similar dimensions as the embodiment of FIGS. 9 and 10 but made of such materials as sheet plastic, such as polystyrene or heavy-duty cardboard or plywood in the same form as above, a paddle portion 126 and a handle portion 128. Each face 122 (appreciative message) or 124 (conciliatory message) have a neutral background such as white and the message in contrasting color such as black, blue, green. The color red is avoided since it is usually associated with danger and that is exactly what is to be avoided. The paddle 120 may easily be stored in vehicle door side pockets or other convenient locations and easily grasped by anyone in the vehicle to send a positive message to nearby cars.

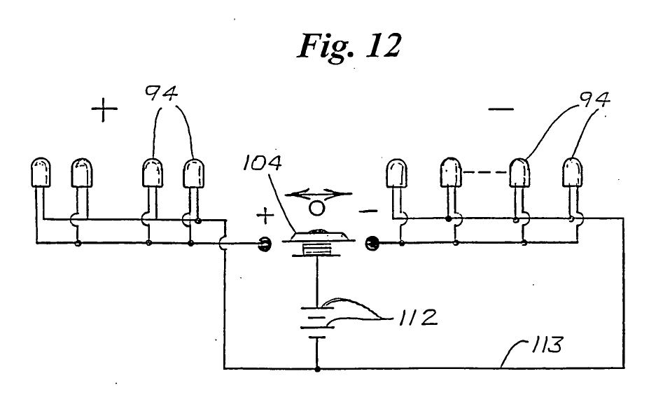

FIG. 12 shows the electrical circuit of the embodiment of FIGS. 10 and 11. It employs a battery 112, which may be two C or D dry cells with one pole (−) connected to a common lead 113 connected to one terminal of two arrays of LEDs 94. The opposite pole (+) of battery 112 is connected to one side of slide switch 104. Switch 104 is shown in its neutral or “O” position and may be slid to the left in the drawing to energize the (+) bank of LEDs 94, which form a positive message or to the right in FIG. 12 to light the negative (−) bank of LEDs illuminate a conciliatory message. The switch 104 is actually mounted for vertical movement up is (+) and down is (−) so there is virtually no likelihood of error in selecting a message.

The Method of Reducing Road Rage

Apart from the apparatus described above, an important aspect of this invention, a method of achieving a reduction of ROAD RAGE, are the fundamental psychological and sociological aspects involved. These include,

1. The recognition that ROAD RAGE is often produced by unintended actions on the part of a driver with respect to a following vehicle.

2. The recognition that an offending driver often recognizes after the occurrence that he may have offended the following vehicle driver but is helpless to effectively communicate with the driver of the following vehicle.

3. The recognition that a simple positive message displayed when the offended driver may view it can well prevent an escalation of the situation.

4. The recognition that a driver who has been assisted by the following driver has little opportunity to express appreciation (the flashing of headlights can be ambiguous).

5. Designing a message system which is effective and unambiguous and positive in nature.

6. Integrating the message system into a vehicle or as an after-market accessory for vehicles.

7. Recognizing that such a message system is not only useful in the rear window of a passenger vehicle but is equally valuable in busses, trucks and trailers of various types.

8. Operating the system, as the driver deems appropriate by operating the control lever and, if necessary, manually cancelling the illumination with the operating lever.

9. The simple hand-held sign provides a message system available at any time, at any place, for everyone.

The above-described embodiments of the present invention are merely descriptive of its principles and are not to be considered limiting. The scope of the present invention instead shall be determined from the scope of the following claims including their equivalents.

1. Apparatus for use in a vehicle for reducing road rage in a highway and street environment comprising:
A housing including a window;
Means within said housing for providing two different visual messages, one of appreciation, e.g. THANK YOU and a second one of conciliatory e.g. SORRY;
Control means for the driver of a vehicle with the apparatus of this invention in place viewable through a window of the vehicle to allow the driver to selectively display one of the messages for viewing by drivers of other vehicles in the vicinity.

2. Apparatus in accord with claim 1 wherein said means for providing said messages is an illuminated sign and said apparatus includes means for powering said Illuminated sign with electric power from the vehicle.

3. Apparatus in accordance with claim 1 wherein said apparatus provides a third message, a request for assistance request, e.g. HELP and said messages are selectable but not changeable by the driver.

4. Apparatus in accordance with claim 1 wherein said control means comprises a selector switch mountable on the steering wheel of the driver's vehicle.

5. Apparatus in accordance with claim 1 wherein said housing defines two compartments behind said window;
A lamp within each compartment;
Template means in said housing including cutouts for the messages to be displayed;
Said templates being located between said lamps and the window for displaying either the appreciation or the conciliatory message.

6. Apparatus in accordance with claim 1 wherein said display of messages comprises an array of LEDs and said apparatus includes a controller for selectively illuminating different combinations of LEDs to provide different appreciation or conciliatory messages.

7. Apparatus for reducing road rage between drivers in the highway and street environment comprising a hand held paddle including a handle and a pair of display faces;
One of said faces including a message of appreciation, e.g. THANK YOU and the second face including a conciliatory message, e.g. SORRY; said messages being of sufficient size to be read by another driver through a window of a nearby vehicle.

8. Apparatus in accordance with claim 7 whereby said paddle includes a power source, at least one switch and lights forming the letters of the messages whereby said messages are selectively illuminated by an occupant of a vehicle.

9. Apparatus in accordance with claim 8 whereby said power source and switch are located in the handle of said paddle.

10. A method for reducing road rage between drivers in a highway or street environment comprising the steps of providing:
A sign carrying a message of appreciation and one of conciliation;
Said sign being of size to be viewed through a window of a vehicle in view of other drivers; and
Providing means whereby the driver of a vehicle may selectively display either message while normally driving their vehicle.

11. A method in accordance with claim 10 wherein the sign provided is selectively illuminated.

12. A method in accordance with claim 10 wherein said method includes the step of providing the messages on a hand-held paddle with a message of appreciation on one face and a conciliatory message on the opposite face
